(19) United States
(12) Patent Application Publication
(10) Pub. No.: US 2013/0003011 A1
(43) Pub. Date: Jan. 3, 2013

(54) Lens Film and Manufacturing Method Thereof

(75) Inventors: Tsai-Fu Tsai, Hsin-Chu (TW); Shih-Ming Chen, Hsin-Chu (TW); Yen-Hei Chiang, Hsin-Chu (TW); Chih-Ho Chiu, Hsin-Chu (TW); Hsi-Chien Lin, Hsin-Chu (TW)

(73) Assignee: AU OPTRONICS CORPORATION, Hsin-Chu (TW)

(21) Appl. No.: 13/400,163

(22) Filed: Feb. 20, 2012

(30) Foreign Application Priority Data
Jul. 1, 2011 (TW) 100123295

(51) Int. Cl. G02F 1/13; B29D 11/00

(52) U.S. Cl. 349/200; 264/2.1; 264/1.32

(57) ABSTRACT

A lens film and a manufacturing method thereof are disclosed. The lens film manufacturing method includes the steps of: forming an alignment film on a glass substrate; rubbing the alignment film along a rubbing direction; dispersing a liquid crystal polymer (LCP) material between the alignment film of the glass substrate and a lens mold; rolling the lens mold along a rolling direction to make the LCP material to form a lens film. A plurality of liquid crystal molecules of the lens film is affected by the alignment film to align along the rubbing direction. The lens film and a base panel having a polarization direction are operated in a LCD apparatus. The angle between the rubbing direction and the polarization direction is less than 15°.

### BACKGROUND OF THE INVENTION

1. Field of the Invention

The invention relates to a liquid crystal display (LCD) apparatus; in particular, to a lens film and manufacturing method thereof applied in a LCD apparatus with 3D display function.

2. Description of the Prior Art

In recent years, with the continuous progress of display technology, the liquid crystal display is mass produced and widely used. It is no doubt that the liquid crystal display has become the mainstream of the flat panel display technology. In addition, because the 3D image contents such as 3D movies and 3D video games are continuously released in the market, the trend that the 3D image display development has entered into the family and personal market from the movie theater is reflected. Therefore, various manufacturers develop and manufacture LCD apparatuses with 3D display function to meet consumer's demand.

In general, the LCD apparatus with 3D display function mainly has two types: the non-naked eye 3D display that the user should wear 3D glasses to watch the 3D display effect of the LCD apparatus and the naked eye 3D display that the user can directly watch the 3D display effect of the LCD apparatus without the 3D glasses. Since the user can use the naked eye 3D display to freely enjoy 3D image without the restriction and inconvenience caused by the 3D glasses, the naked eye 3D display is widely received by consumers.

The 3D display technology used in current naked eye 3D display can be Parallax Barrier type, Lenticular Lens type, or Directional Backlight type. As Lenticular Lens type 3D display technology, it uses the 3D lens film formed by the liquid crystal polymer (LCP) material to refract the lights, so that the left eye and the right eye of the user can see different images respectively. Different from the Parallax Barrier type technology, grating is not used in the Lenticular Lens type technology, therefore, the light efficiency will be higher without being blocked by the grating, and the system heat and power consumption will not largely increased because of displaying 3D images.

From the above, the 3D display effect shown on the naked eye 3D display using double convex lens mainly depends on the alignment capability of the 3D lens film formed by the LCP material. However, the alignment capability of this 3D lens film is easily affected by manufactory processes such as the rubbing direction, the rolling direction, and the aligning direction of liquid crystal molecules of the lens film, and the 3D display effect of the liquid crystal display apparatus using this 3D lens film will become poor accordingly.

### SUMMARY OF THE INVENTION

Therefore, a scope of the invention is to provide a lens film and manufacturing method thereof to solve the above-mentioned problems.

In an embodiment, the lens film manufacturing method of the invention includes steps of: forming an alignment film on a glass substrate; rubbing the alignment film along a rubbing direction; dispersing a liquid crystal polymer (LCP) material between the alignment film of the glass substrate and a lens mold; rolling the lens mold along a rolling direction to make the LCP material to form a lens film. Wherein, a plurality of liquid crystal molecules of the lens film is affected by the alignment film to align along the rubbing direction, the lens film is operated with a base panel having a polarization direction in a LCD apparatus, and the angle between the rubbing direction and the polarization direction is less than 15°.

In an embodiment, in the LCD apparatus, the lens film and the base panel are cooperated with the switching of a switch cell to selectively operate under a first liquid crystal driving mode or a second liquid crystal driving mode.

In an embodiment, the first liquid crystal driving mode is Twisted Nematic (TN) liquid crystal driving mode, under the TN liquid crystal driving mode, an angle between the polarization direction of the base panel and the horizontal direction is 45° or 135°.

In an embodiment, if the angle between the polarization direction of the base panel and the horizontal direction is 45°, an angle between the rubbing direction and the horizontal direction is between 30° and 60°, and an angle between the aligning direction of a plurality of micro lens units of the lens film and the horizontal direction is between 90° and 180°.

In an embodiment, if the angle between the polarization direction of the base panel and the horizontal direction is 135°, an angle between the rubbing direction and the horizontal direction is between 120° and 150°, and an angle between the aligning direction of a plurality of micro lens units of the lens film and the horizontal direction is between 0° and 90°.

In an embodiment, under the TN liquid crystal driving mode, index of refraction of the lens film is higher than that of the lens mold.

In an embodiment, the second liquid crystal driving mode is Vertical Alignment (VA) liquid crystal driving mode, In Panel Switching (IPS) liquid crystal driving mode, or Fringe Field Switching (FFS) wide viewing angle liquid crystal driving mode, under the second liquid crystal driving mode, an angle between the polarization direction of the base panel and the horizontal direction is 0°, an angle between the rubbing direction and the horizontal direction is between −15° and 15°, and an angle between the aligning direction of a plurality of micro lens units of the lens film and the horizontal direction is between 60° and 120°.

In an embodiment, under the second liquid crystal driving mode, index of refraction of the lens film is equal to that of the lens mold.

In an embodiment, an angle between the rubbing direction and the rolling direction is smaller than 90°.

In an embodiment, an angle between the rolling direction and the aligning direction of a plurality of micro lens units of the lens film is smaller than 45°.

In an embodiment, the lens mold includes a plurality of concave portions, when the lens mold is rolled, the LCP material will be filled into the plurality of concave portions to form the lens film having a plurality of micro lens units, and the aligning direction of the plurality of micro lens units of the lens film relates to the aligning direction of the plurality of concave portions of the lens mold.

In another embodiment, the lens film of the invention is formed by a LCP material and cooperated with a base panel having a polarization direction to operate in a LCD apparatus. The lens film includes a plurality of liquid crystal molecules. The plurality of liquid crystal molecules is affected by an alignment film on a glass substrate to align along a rubbing direction, and the alignment film on the glass substrate being rubbed along the rubbing direction. An angle between the rubbing direction and the polarization direction is smaller than 15°.

Compared to the prior arts, the lens film manufacturing method of the invention controls the rubbing direction of the alignment film and the rolling direction of the lens mold in the lens film manufacturing process to improve the alignment capability of the 3D lens film formed by the LCP material, therefore, the LCD apparatus using the lens film can show better naked eye 3D display effect than that of the prior arts.

The advantage and spirit of the invention may be understood by the following detailed descriptions together with the appended drawings.

### BRIEF DESCRIPTION OF THE APPENDED DRAWINGS

FIG. 1 illustrates a flowchart of the lens film manufacturing method in a preferred embodiment of the invention.

FIG. 2A illustrates a schematic diagram of forming an alignment film on a glass substrate.

FIG. 2B illustrates a schematic diagram of rubbing the alignment film along a rubbing direction.

FIG. 2C illustrates a schematic diagram of dispersing a LCP material between the alignment film of the glass substrate and a lens mold.

FIG. 2D illustrates a schematic diagram of rolling the lens mold along a rolling direction to make the LCP material to form a lens film.

FIG. 2E illustrates a schematic diagram of performing a UV curing to the lens film.

FIG. 2F illustrates a schematic diagram of the lens film and lens mold obtained eventually.

FIG. 2G illustrates a preferred embodiment of the angle between the rubbing direction and the rolling direction.

FIG. 2H illustrates a preferred embodiment of the angle between the rolling direction and the aligning direction of the micro lens units of the lens film.

FIG. 3A illustrates a schematic diagram of the lens film, the lens mold, and the base panel of the LCD apparatus operated under a first liquid crystal driving mode (3D display mode).

FIG. 3B illustrates a schematic diagram of the lens film, the lens mold, and the base panel of the LCD apparatus operated under a second liquid crystal driving mode (2D display mode).

FIG. 4A illustrates a preferred embodiment of the angle between the rubbing direction and the horizontal direction and the angle between the aligning direction of the micro lens units of the lens film and the horizontal direction if the angle between the polarization direction of the base panel and the horizontal direction is 45° under the first liquid crystal driving mode (3D display mode).

FIG. 4B illustrates a preferred embodiment of the angle between the rubbing direction and the horizontal direction and the angle between the aligning direction of the micro lens units of the lens film and the horizontal direction if the angle between the polarization direction of the base panel and the horizontal direction is 135° under the first liquid crystal driving mode (3D display mode).

FIG. 4C illustrates a preferred embodiment of the angle between the rubbing direction and the horizontal direction and the angle between the aligning direction of the micro lens units of the lens film and the horizontal direction under the second liquid crystal driving mode (2D display mode).

### DETAILED DESCRIPTION OF THE INVENTION

A preferred embodiment of the invention is a lens film manufacturing method. In this embodiment, the lens film manufacturing method is used to manufacture a lens film applied in a LCD apparatus, and the lens film is cooperated with a base panel having a polarization direction in the LCD apparatus, but not limited to this.

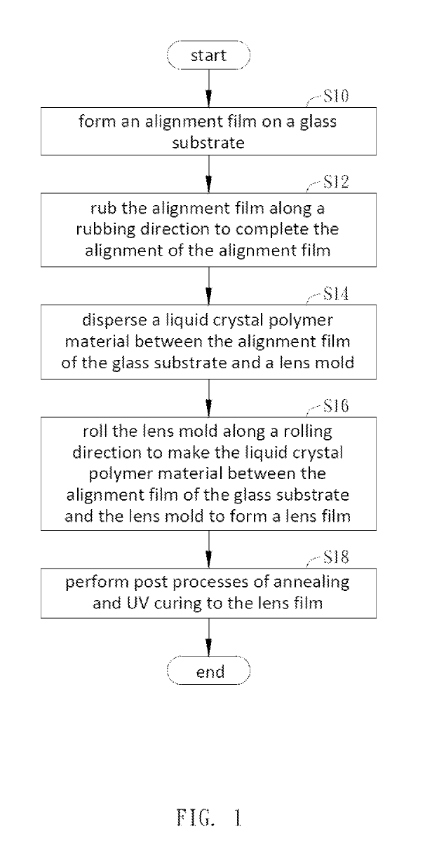

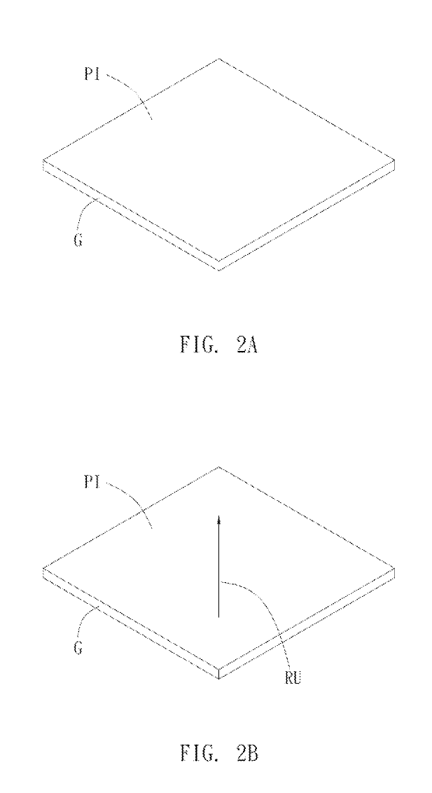

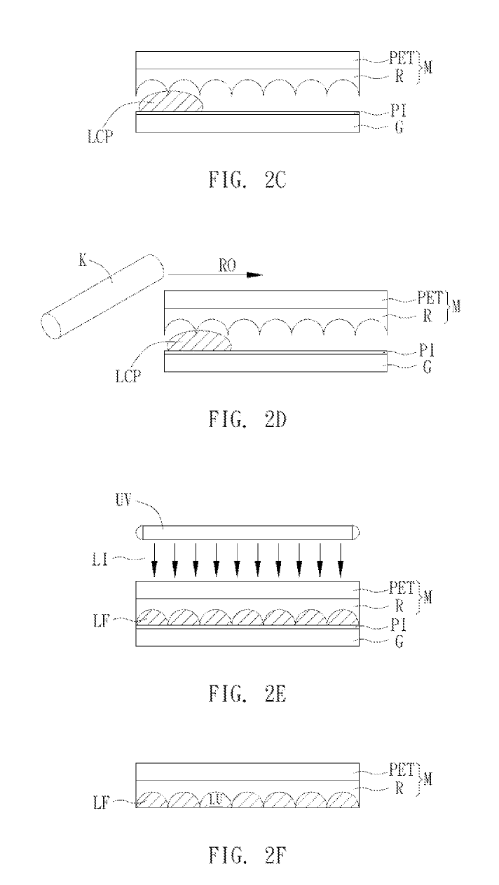

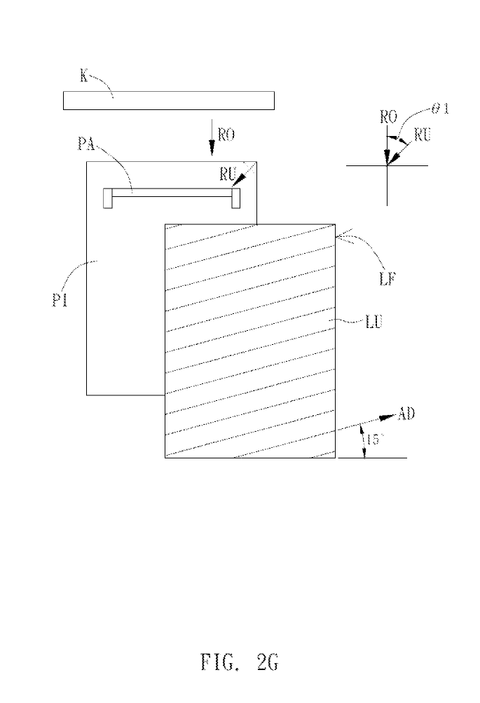

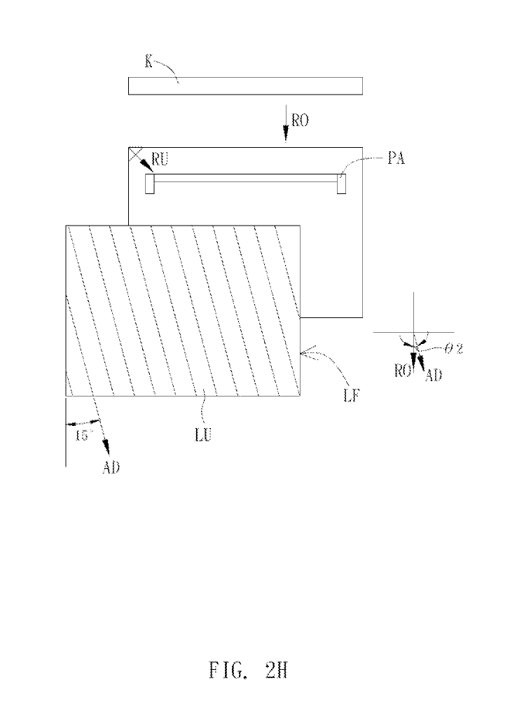

Please refer to FIG. 1. FIG. 1 illustrates a flowchart of the lens film manufacturing method. As shown in FIG. 1, at first, the method performs the step S10 to form an alignment film PI on a glass substrate G, and the schematic diagram of forming the alignment film PI on the glass substrate G is shown in FIG. 2A. In practical applications, the glass substrate G can be ITO conductive glass. The alignment film PI formed on the glass substrate G can be formed by Polymide (PI), and the alignment film PI can be formed on the glass substrate G by the way of evaporation, inkjet printing, or coating, but not limited to this.

Then, the method performs the step S12 to rub the alignment film PI along a rubbing direction RU to complete the alignment of the alignment film PI, and the schematic diagram of rubbing the alignment film PI along the rubbing direction RU is shown in FIG. 2B. In this embodiment, the step S12 is to contact with the surface of the alignment film PI and to do a forward mechanical friction behavior on the surface, and the energy provided by rubbing the polymer surface will make the main chain of the polymer to be extended and forward aligned. In fact, the rubbing direction RU is close to the polarization direction of the base panel, in general, it is preferred that the angle between the rubbing direction and the polarization direction of the base panel is less than 15°, but not limited to this.

Afterward, the method performs the step S14 to disperse a liquid crystal polymer material LCP between the alignment film PI of the glass substrate G and a lens mold M, and the schematic diagram of dispersing the liquid crystal polymer material LCP between the alignment film PI of the glass substrate G and the lens mold M is shown in FIG. 2C. In this embodiment, the lens mold M is formed by the UV curing resin R which is formed on the Polyethylene Terephthalate PET, and as shown in FIG. 2C, the lens mold M includes a plurality of concave portions NL having a concave shape, but not limited to this.

Then, then method performs the step S16 to roll the lens mold M along a rolling direction RO to make the liquid crystal polymer material LCP between the alignment film PI of the glass substrate G and the lens mold M to form a lens film LF. The schematic diagram of rolling the lens mold M along the rolling direction RO is shown in FIG. 2D, and the method can use the roller K of FIG. 2D, but not limited to this. At last, the method performs the step S18 to perform the post processes of annealing and UV curing to the lens film LF, and the manufacturing process of the lens film LF can be completed. FIG. 2F illustrates a schematic diagram of the lens film and lens mold obtained eventually.

In this embodiment, because the lens mold M includes the plurality of concave portions NL having a concave shape, when the lens mold M is rolled, the liquid crystal polymer material LCP will be filled into the plurality of concave portions NL to form the lens film LF having a plurality of micro lens units LU, and the aligning direction of the plurality of micro lens units LU of the lens film LF relates to the aligning direction of the plurality of concave portions NL of the lens mold M.

It should be noticed that the lens film LF obtained by the method performing the step S16 is formed by the liquid crystal polymer material LCP, therefore, the lens film LF includes a plurality of liquid crystal molecule, and when the lens mold M is rolled, the plurality of liquid crystal molecule in the lens film LF will be affected by the alignment film PI and aligned along the rubbing direction RU.

Please refer to FIG. 2G and FIG. 2H. FIG. 2G illustrates a top-view of a preferred embodiment of the angle between the rubbing direction and the rolling direction; FIG. 2H illustrates a top-view of a preferred embodiment of the angle between the rolling direction and the aligning direction of the micro lens units of the lens film. Wherein, the roller K rolls along the rolling direction RO; RU is the rubbing direction; AD is the aligning direction of the micro lens units LU of the lens film LF, in this embodiment, the angle between the aligning direction AD and the horizontal direction is 15°; the alignment film PI has a liquid crystal pattern PA, and the shape and size of the liquid crystal pattern PA can be determined based on practical needs without any limitations.

In this embodiment, it is preferred that the angle θ1 between the rubbing direction RU and the rolling direction RO is smaller than 90°; it is preferred that the angle θ2 between the rolling direction RO and the aligning direction AD of the micro lens units LU of the lens film LF is smaller than 45°. It should be noticed that the above-mentioned conditions can help to enhance the alignment capability of the lens film LF formed by the liquid crystal polymer material LCP; therefore, the LCD apparatus can show better naked eye 3D display effect. Once the angle θ1 between the rubbing direction RU and the rolling direction RO is larger than 90° or the angle θ2 between the rolling direction RO and the aligning direction AD of the micro lens units LU of the lens film LF is larger than 45°, the alignment capability of the lens film LF will become poor, and the naked eye 3D display effect shown on the LCD apparatus will become poor.

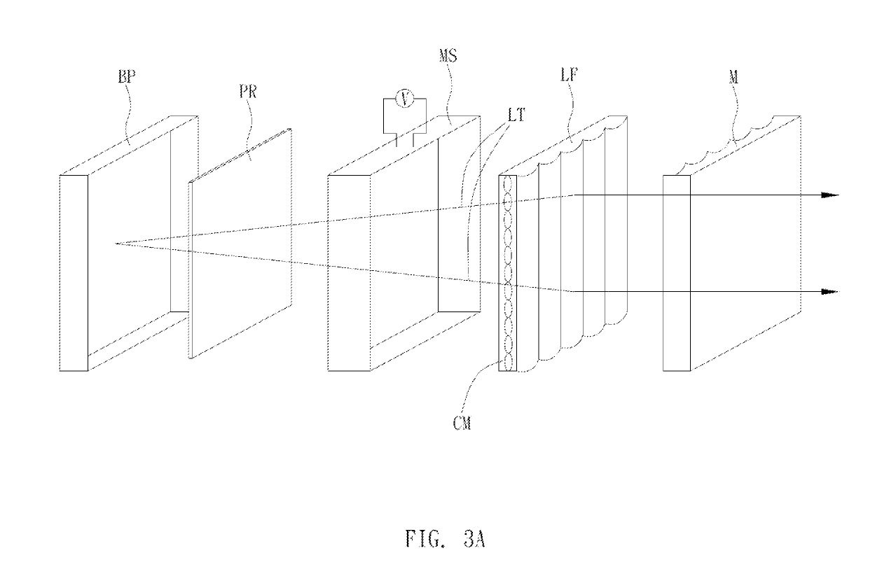

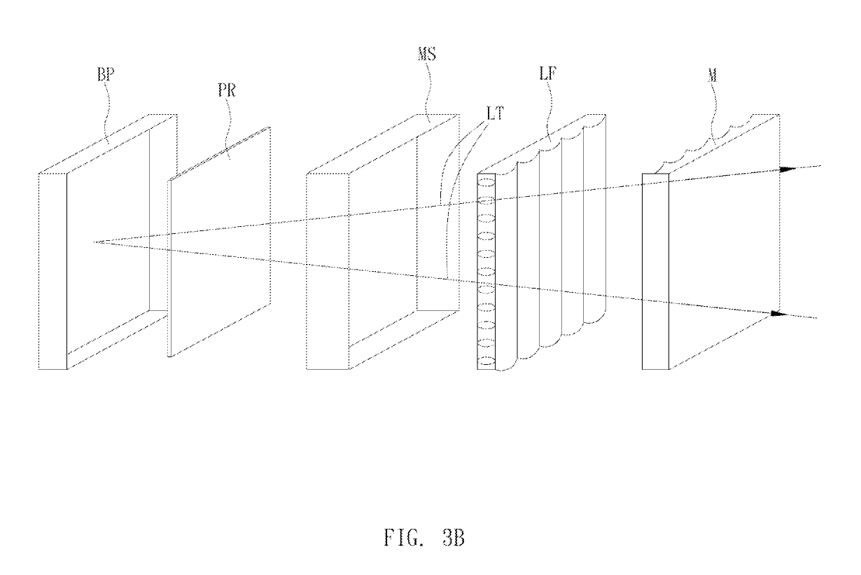

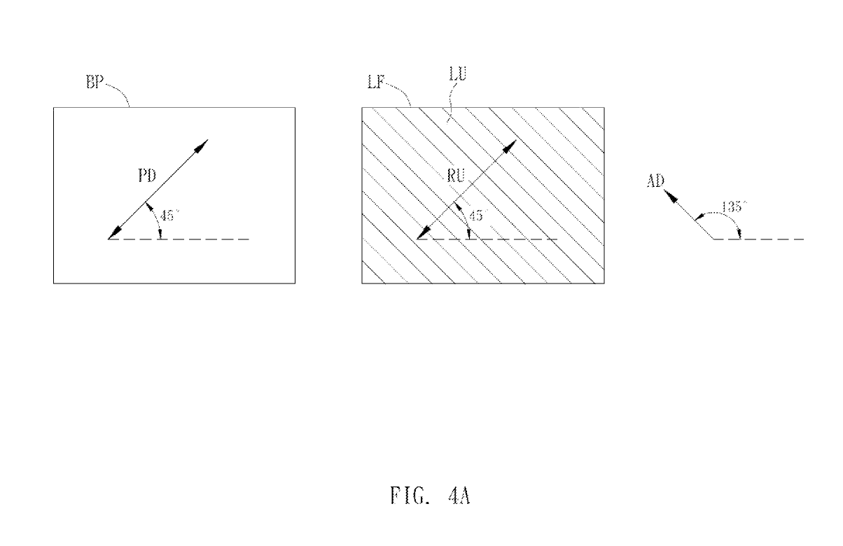

Please refer to FIG. 3A and FIG. 3B. In the LCD apparatus 3 having naked eye 3D display function, the lens film LF manufactured by the above-mentioned lens film manufacturing method, the lens mold M, the base panel BP, and a polarizer PR are cooperated with the switching of a switch cell MS to selectively operate under a first liquid crystal driving mode or a second liquid crystal driving mode. In a preferred embodiment, when the switch cell MS is turned on by a voltage V, the switch cell MS switches the lens film LF, the lens mold M, and the base panel BP to operate under the first liquid crystal driving mode (the 3D display mode); when the switch cell MS is turned off, the lens film LF, the lens mold M, and the base panel BP are operated under the second liquid crystal driving mode (the 2D display mode).

Because ordinary users still use the 2D display mode of the LCD apparatus 3 in most of time, the voltage V is provided only when the switch cell MS switches to the 3D display mode in this preferred embodiment, so that the power consumption of the LCD apparatus 3 can be effectively saved. However, in practical applications, the LCD apparatus 3 can be also set that the voltage V is provided only when the switch cell MS switches to the 2D display mode, there is no specific limitations.

It should be noticed that in this preferred embodiment, the first liquid crystal driving mode (the 3D display mode) can be Twisted Nematic (TN) liquid crystal driving mode; the second liquid crystal driving mode (the 2D display mode) can be Vertical Alignment (VA) liquid crystal driving mode, In Panel Switching (IPS) liquid crystal driving mode, or Fringe Field Switching (FFS) wide viewing angle liquid crystal driving mode, but not limited to this.

Next, the first liquid crystal driving mode (the 3D display mode) and the second liquid crystal driving mode (the 2D display mode) of this preferred embodiment will be introduced respectively.

As shown in FIG. 3A, when the switch cell MS is turned on by the voltage V and switches to the first liquid crystal driving mode (the 3D display mode), namely Twisted Nematic (TN) liquid crystal driving mode, the liquid crystal molecules CM in the lens film LF will be horizontally aligned side by side, so that index of refraction of the lens film LF will be higher than that of the lens mold M, and the lens film LF can achieve the effect of refracting the lights LT. In addition, under TN liquid crystal driving mode, it is preferred that the angle between the polarization direction PD of the base panel BP and the horizontal direction is 45° or 135°.

If the angle between the polarization direction PD of the base panel BP and the horizontal direction is 45°, it is preferred that the angle between the rubbing direction RU and the horizontal direction is between 30° and 60°, and the angle between the aligning direction AD of the micro lens units LU of the lens film LF and the horizontal direction is between 90° and 180°. Because the above-mentioned conditions can enhance the alignment capability of the lens film LF formed by the LCP material, the LCD apparatus can show better naked eye 3D display effect.

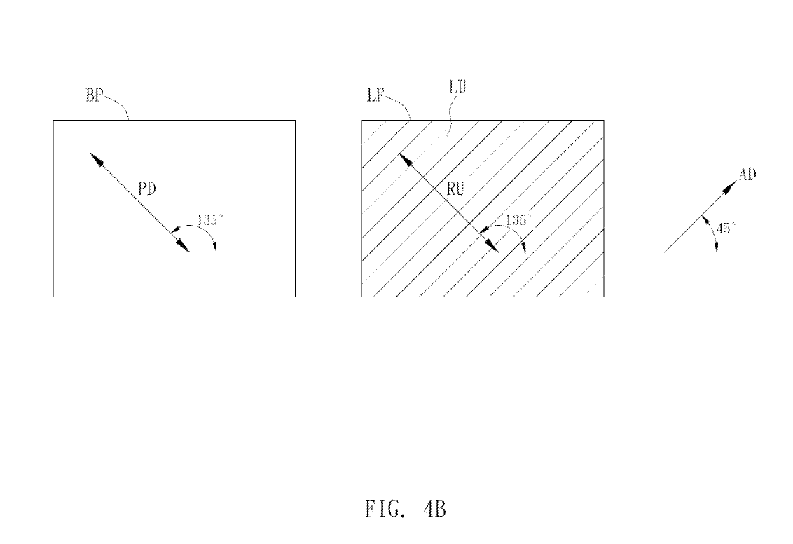

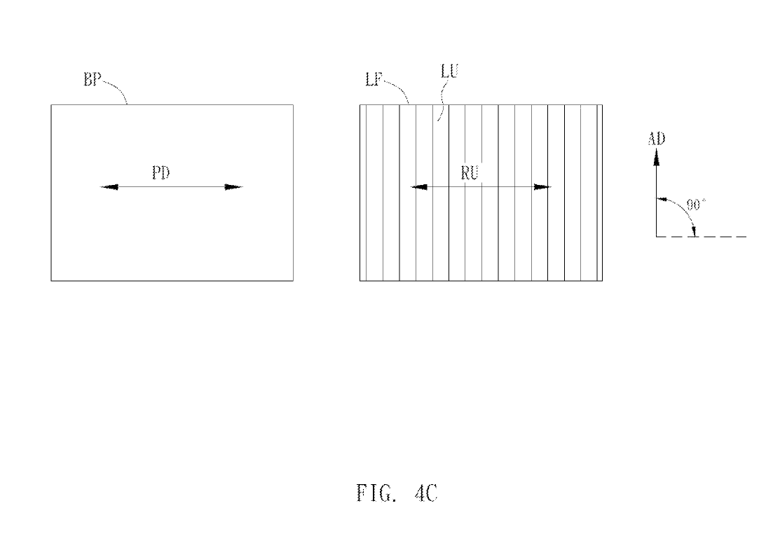

In a preferred embodiment, as shown in FIG. 4A, if the angle between the polarization direction PD of the base panel BP and the horizontal direction is 45°, the angle between the rubbing direction RU and the horizontal direction can be 45° and the angle between the aligning direction AD of the micro lens units LU of the lens film LF and the horizontal direction can be 135°. At this time, the angle between the rubbing direction RU and the aligning direction AD of the micro lens units LU of the lens film LF is 90°, that is to say, the rubbing direction RU is vertical to the aligning direction AD of the micro lens units LU of the lens film LF. Therefore, the LCD apparatus can show good naked eye 3D display effect without unwanted mura phenomenon of uneven brightness.

If the angle between the polarization direction PD of the base panel BP and the horizontal direction is 135°, it is preferred that the angle between the rubbing direction RU and the horizontal direction is between 120° and 150°, and the angle between the aligning direction AD of the micro lens units LU of the lens film LF and the horizontal direction is between 0° and 90°. Because the above-mentioned conditions can enhance the alignment capability of the lens film LF formed by the LCP material, the LCD apparatus can show better naked eye 3D display effect.

In a preferred embodiment, as shown in FIG. 4B, if the angle between the polarization direction PD of the base panel BP and the horizontal direction is 135°, the angle between the rubbing direction RU and the horizontal direction can be 135° and the angle between the aligning direction AD of the micro lens units LU of the lens film LF and the horizontal direction can be 45°. At this time, the angle between the rubbing direction RU and the aligning direction AD of the micro lens units LU of the lens film LF is 90°, that is to say, the rubbing direction RU is vertical to the aligning direction AD of the micro lens units LU of the lens film LF. Therefore, the LCD apparatus can show good naked eye 3D display effect without unwanted mura phenomenon of uneven brightness.

As shown in FIG. 3B, under the second liquid crystal driving mode (the 2D display mode), namely Vertical Alignment (VA) liquid crystal driving mode, In Panel Switching (IPS) liquid crystal driving mode, or Fringe Field Switching (FFS) wide viewing angle liquid crystal driving mode, the liquid crystal molecules CM in the lens film LF will be aligned in parallel and vertical to the lens film LF, so that index of refraction of the lens film LF will be equal to that of the lens mold M, and the lens film LF will not refract the lights LT. In addition, under the second liquid crystal driving mode, the angle between the polarization direction PD of the base panel BP and the horizontal direction is 0°. It is preferred that the angle between the rubbing direction RU and the horizontal direction is between −15° and 15°, and the angle between the aligning direction AD of the micro lens units LU of the lens film LF and the horizontal direction is between 60° and 120°.

For example, as shown in FIG. 4C, if the angle between the polarization direction PD of the base panel BP and the horizontal direction is 0°, the angle between the rubbing direction RU and the horizontal direction can be 0°, and the angle between the aligning direction AD of the micro lens units LU of the lens film LF and the horizontal direction can be 90°, but not limited to this.

Another preferred embodiment of the invention is a lens film. In this embodiment, the lens film is formed by a LCP material and cooperated with a base panel having a polarization direction to operate in a LCD apparatus. The lens film includes a plurality of liquid crystal molecules. The plurality of liquid crystal molecules is affected by an alignment film on a glass substrate to align along a rubbing direction, and the alignment film on the glass substrate being rubbed along the rubbing direction. An angle between the rubbing direction and the polarization direction is smaller than 15°. As to the detailed introduction of the lens film in this embodiment, please refer to the description and figures of the above-mentioned embodiment, and they will not be repeated here.

Compared to the prior arts, the lens film manufacturing method of the invention controls the rubbing direction of the alignment film and the rolling direction of the lens mold in the lens film manufacturing process to improve the alignment capability of the 3D lens film formed by the LCP material, therefore, the LCD apparatus using the lens film can show better naked eye 3D display effect than that of the prior arts.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A lens film manufacturing method, comprising steps of:
forming an alignment film on a glass substrate;
rubbing the alignment film along a rubbing direction;
dispersing a liquid crystal polymer (LCP) material between the alignment film of the glass substrate and a lens mold; and
rolling the lens mold along a rolling direction to make the LCP material to form a lens film;
wherein a plurality of liquid crystal molecules of the lens film is affected by the alignment film to align along the rubbing direction, the lens film and a base panel having a polarization direction are operated in a LCD apparatus, and the angle between the rubbing direction and the polarization direction is less than 15°.

2. The lens film manufacturing method of claim 1, wherein in the LCD apparatus, the lens film and the base panel are cooperated with the switching of a switch cell to selectively operate under a first liquid crystal driving mode or a second liquid crystal driving mode.

3. The lens film manufacturing method of claim 2, wherein the first liquid crystal driving mode is Twisted Nematic (TN) liquid crystal driving mode, under the TN liquid crystal driving mode, an angle between the polarization direction of the base panel and the horizontal direction is 45° or 135°.

4. The lens film manufacturing method of claim 3, wherein if the angle between the polarization direction of the base panel and the horizontal direction is 45°, an angle between the rubbing direction and the horizontal direction is between 30° and 60°, and an angle between the aligning direction of a plurality of micro lens units of the lens film and the horizontal direction is between 90° and 180°.

5. The lens film manufacturing method of claim 3, wherein if the angle between the polarization direction of the base panel and the horizontal direction is 135°, an angle between the rubbing direction and the horizontal direction is between 120° and 150°, and an angle between the aligning direction of a plurality of micro lens units of the lens film and the horizontal direction is between 0° and 90°.

6. The lens film manufacturing method of claim 3, wherein under the TN liquid crystal driving mode, index of refraction of the lens film is higher than that of the lens mold.

7. The lens film manufacturing method of claim 2, wherein the second liquid crystal driving mode is Vertical Alignment (VA) liquid crystal driving mode, In Panel Switching (IPS) liquid crystal driving mode, or Fringe Field Switching (FFS) wide viewing angle liquid crystal driving mode, under the second liquid crystal driving mode, an angle between the polarization direction of the base panel and the horizontal direction is 0°, an angle between the rubbing direction and the horizontal direction is between −15° and 15°, and an angle between the aligning direction of a plurality of micro lens units of the lens film and the horizontal direction is between 60° and 120°.

8. The lens film manufacturing method of claim 7, wherein under the second liquid crystal driving mode, index of refraction of the lens film is equal to that of the lens mold.

9. The lens film manufacturing method of claim 1, wherein an angle between the rubbing direction and the rolling direction is smaller than 90°.

10. The lens film manufacturing method of claim 1, wherein an angle between the rolling direction and the aligning direction of a plurality of micro lens units of the lens film is smaller than 45°.

11. The lens film manufacturing method of claim 1, wherein the lens mold comprises a plurality of concave portions, when the lens mold is rolled, the LCP material will be filled into the plurality of concave portions to form the lens film having a plurality of micro lens units, and the aligning direction of the plurality of micro lens units of the lens film relates to the aligning direction of the plurality of concave portions of the lens mold.

12. A lens film formed by a LCP material and cooperated with a base panel having a polarization direction to operate in a LCD apparatus, the lens film comprising:
a plurality of liquid crystal molecules, affected by an alignment film on a glass substrate to align along a rubbing direction, and the alignment film on the glass substrate being rubbed along the rubbing direction, an angle between the rubbing direction and the polarization direction is smaller than 15°.

13. The lens film of claim 12, wherein the LCD apparatus further comprises a mode switching unit, the lens film and the base panel are cooperated with the switching of a switch cell to selectively operate under a first liquid crystal driving mode or a second liquid crystal driving mode.

14. The lens film of claim 13, wherein the first liquid crystal driving mode is Twisted Nematic (TN) liquid crystal driving mode, under the TN liquid crystal driving mode, an angle between the polarization direction of the base panel and the horizontal direction is 45° or 135°.

15. The lens film of claim 14, wherein if the angle between the polarization direction of the base panel and the horizontal direction is 45°, an angle between the rubbing direction and the horizontal direction is between 30° and 60°, and an angle between the aligning direction of a plurality of micro lens units of the lens film and the horizontal direction is between 90° and 180°.

16. The lens film of claim 14, wherein if the angle between the polarization direction of the base panel and the horizontal direction is 135°, an angle between the rubbing direction and the horizontal direction is between 120° and 150°, and an angle between the aligning direction of a plurality of micro lens units of the lens film and the horizontal direction is between 0° and 90°.

17. The lens film of claim 13, wherein the second liquid crystal driving mode is Vertical Alignment (VA) liquid crystal driving mode, In Panel Switching (IPS) liquid crystal driving mode, or Fringe Field Switching (FFS) wide viewing angle liquid crystal driving mode, under the second liquid crystal driving mode, an angle between the polarization direction of the base panel and the horizontal direction is 0°, an angle between the rubbing direction and the horizontal direction is between −15° and 15°, and an angle between the aligning direction of a plurality of micro lens units of the lens film and the horizontal direction is between 60° and 120°.

18. The lens film of claim 12, wherein the LCP material is dispersed between the alignment film of the glass substrate and a lens mold, and the lens mold is rolled along a rolling direction to make the LCP material to form the lens film.

19. The lens film of claim 18, wherein the lens mold comprises a plurality of concave portions, when the lens mold is rolled, the LCP material will be filled into the plurality of concave portions to form the lens film having a plurality of micro lens units, and the aligning direction of the plurality of micro lens units of the lens film relates to the aligning direction of the plurality of concave portions of the lens mold.
